(19) United States
(12) Patent Application Publication
(10) Pub. No.: US 2008/0237926 A1
(43) Pub. Date: Oct. 2, 2008

(54) Process for the Manufacture of Oriented Polymer Strips

(75) Inventors: Pierre Matz, Nil Saint-Vicent (BE); Frederic Beullekens, Rixensart (BE); Claude Dehennau, Waterloo (BE)

Correspondence Address: OCCHIUTI ROHLICEK & TSAO, LLP, 10 FAWCETT STREET, CAMBRIDGE, MA, 02138, US

(73) Assignee: EGEPLAST WERNER STRUMANN GMBH & CO. KG, Greven (DE)

(21) Appl. No.: 12/063,487

(22) PCT Filed: Aug. 9, 2006
(86) PCT No.: PCT/EP06/07883

§ 371 Date: Feb. 11, 2008

(30) Foreign Application Priority Data
Aug. 11, 2005 (EP) 05107371.6

(51) Int. Cl. B29C 55/06

(52) U.S. Cl. 264/288.4

(57) ABSTRACT

A process for the manufacture of an oriented strip comprising a semi-crystalline polymer according to which a film comprising said polymer is drawn in a longitudinal direction on a length L between 2 points at which the film moves at a respective linear velocity of V1 and V2 during its drawing, characterized in that V₁, v₃ and L answer the following criteria: (v₂−V₁)/L>0.22 s⁻¹.

The present invention relates to a process for the manufacture of oriented polymer strips and to the use of said oriented polymer strips for reinforcing tubes.

It is known from prior art that stretching a semi-crystalline polymer film at a temperature slightly below its melting temperature in its longitudinal direction results in a mono-axial orientation of the polymer chains. Such mono-axially oriented polymer films exhibit in the longitudinal direction, certain mechanical properties which are superior over the properties of non-oriented polymer films.

There are a number of solid state orientation processes that have been used to produce highly oriented, high modulus polymers. These processes include drawing, extrusion and rolling. All three techniques rely on realigning the existing crystal structure into a highly oriented fibrillar structure by an extension deformation process. Each of these techniques also has several variations and unique features associates with it. Drawing can be isothermal or non-isothermal, free or constrained deformation. Extrusion can be direct or hydrostatic, adiabatic or isothermal. Rolling can be with or without tension, adiabatic or isothermal.

It is well known that during mono-axial orientation, films tend to neck. Besides, while the orientation of the polymer chains renders a polymer film reinforced in longitudinal direction, its fragility in transverse direction is usually increased. The fragility in transverse direction does not significantly impair the reinforcement effect in longitudinal direction, but causes problems regarding the processability of the polymer film, particularly when it is intended to cut off its edges in order to obtain oriented polymer strips having precise dimensions.

For example, mono-axially oriented polymer films having precise dimensions become particularly relevant when they are used to enhance the mechanical stability of tubes. Reinforcing polymer strips made of mono-axially oriented polymer films may be applied to tubes for enhancing their resistance against hydrostatic pressure. In comparison to conventional tubes not supported by said reinforcing polymer strips, the working pressure may be increased or the thickness of the tube, which is required to withstand the pressure the tube is exposed to, may be decreased. In order to achieve an optimal stabilizing effect the reinforcing polymer strips should be fixed on the cylinder jacket of said tubes in a certain angle (preferably 54.7° relative to the longitudinal axis of the tube). Furthermore, it is required that the reinforcing polymer strips cover the entirety of the tube thereby avoiding gaps between successive windings to achieve a homogenous reinforcement of the tube. However, this may only be realized if the reinforcing polymer strips have a constant and precise width. For further details it can be referred to e.g. FR-A 2 836 652, WO 02/87874 and WO 02/88589. When tubes wrapped by such reinforcing polymer strips are tested for their stability limit (bursting test), the reinforcing polymer strips usually crack causing a deafening noise.

When the edges of conventional mono-axially oriented polymer films are subjected to cutting tools, most of them fail to provide straight cutting edges but rather end up with fringes, fissures and the like. Only cutter systems based on CO₂ lasers or water jets may provide cuts of adequate quality. However, these systems are very expensive when compared with conventional cutter systems. Moreover, when cut with a CO₂ laser, certain polymers may release toxic fumes which require troublesome purification for economical reasons. When a water jet is used as a cutter system, a further process step is required, as the strips usually need purification after cutting.

Thus, there is a demand for polymer films which have advantages over the prior art and, in particular, the edges of which may be subjected to conventional cutting tools. The polymer films should have comparable, preferably better properties than the polymer films of the prior art, in particular, they should combine a good reinforcing effect in longitudinal direction with a decreased fragility in transverse direction and a good ability of being cut.

U.S. Pat. No. 4,151,245 discloses a method of stretching a thermo-softening high molecular film comprising the steps of moving the thermo-softening high molecular film in a longitudinal direction while maintaining the film at a temperature below its softening temperature, and exerting on the surface of such film a force tending to expand the film while at the same time exerting a compressive force on the film in the direction of its thickness through rubber-like resilient members. By doing so, the film is prevented from necking. However, in this document, it is recommended not to stretch the film more than 1.2 to 1.5 times its original length, so that it is necessary to perform the stretching operation several times in order to stretch the film satisfactorily.

It has now been surprisingly found that even better mechanical properties can be achieved if necking takes place and is even passed beyond, but in a specific way: by drawing the polymer film at a very high relative drawing ratio (i.e. at a very high ratio on a very short distance). In fact, upon drawing a given length of semi-crystalline polymer film at an increasing drawing ratio, said film usually necks till it reaches a minimum width. But if thereafter, the drawing ratio is still increased, the width of the film will increase again (probably due to the fact that the molecular entanglements are then solicited) and reach a “plateau” value, after which the film will brake. Films which were stretched beyond the critical drawing ratio (where maximum necking occurs) show remarkable, unexpected properties.

Accordingly, the present invention relates to a process for the manufacture of an oriented strip comprising a semi-crystalline polymer according to which a film comprising said polymer is drawn in a longitudinal direction on a length L between 2 points at which the film moves at a respective linear velocity of v₁ and v₂ during its drawing, characterized in that v₁, v₂ and L answer the following criteria: (v₂−v₁)/L>0.22 s⁻¹.

According to the invention, semi-crystalline polymer films are drawn into strips. The term “film” as used for the present specification refers to a film, sheet, web and the like. The term “semi-crystalline polymer” is meant to designate a polymer which crystallizes to some extent after solidification from the melted state. It is hence a thermoplastic material (since it has to melt) which may be an engineering polymer (like PA (polyamide) or PVDF (polyvinylidene fluoride)) or a polyolefin. It is preferably a polyolefin and most preferably, a polyethylene like HDPE (high density polyethylene). Good results have been obtained with bi-modal HDPE resins and more particularly, with such resins having a MI (Melt Index according to ISO 1133 under 5 kg and 190° C.) of less than 2 g/10 min, preferably less than 1 g/10 min.

According to the invention, the film must be drawn at a high speed (using a high drawing ratio) on a short distance. This has been quantified by a relative drawing speed i.e. the difference of the speed of the film between 2 points of it divided by the length between said points: (v₂−v₁)/L. According to the invention, this relative drawing speed must be ≧0.22 expressed in s⁻¹ (or 25/s). More preferably, said relative drawing speed is ≧0.25 and even ≧0.28 s⁻¹. In some cases, depending on the polymer's nature and the drawing conditions, this relative drawing speed may even be ≧0.30 s⁻¹ and the film still gets improved properties without breaking.

According to one embodiment of the present invention, the stretching of the polymer films is performed by means of succeeding rolls on which the film must adhere, said rolls rotating with different tangential velocities thereby resulting in an orientation of the polymer chains. Such rolls are well known to a person of ordinary skill in the art. They are generally made of a hard metal (like steel) core, and are controlled as far as there temperature, pressure . . . are concerned. They may have a cylinder jacked around their metal core, which may be of metal as well or of another material (like rubber for instance) and which may be surface treated.

In practice, in order to be able to reach such high relative drawing speeds, the film is preferably prevented from slipping of the rolls by using a contrarotative auxiliary roll at least on the first drawing roll (because it is usually from this one that it tends to slip) and/or by surface treating the drawing rolls so as to improve adhesion of the film thereon. In the first case, the contrarotating auxiliary roll preferably has its axis of rotation perpendicular to the longitudinal direction of the polymer film and rotates with the same tangential velocity v1 as the first roll but in the opposite sense. In any case, good results are obtained when putting said film in contact with a big part of the circumference of each roll (ideally, with the maximum possible i.e. about half of it).

Preferably, the film is also prevented from slipping of the second drawing roll by means of a second contrarotating auxiliary roll.

Hence, according to an advantageous embodiment of the invention, the drawing is made by means of at least 2 independently driven drawing rolls having their axes of rotation perpendicular to the longitudinal direction of the polymer film and rotating in the same sense but with different tangential velocities v₁ and v₂, and the film is prevented from slipping of these drawing rolls by means of contrarotating auxiliary rolls, having their axis of rotation perpendicular to the longitudinal direction of the polymer film and rotating with the same tangential velocity but in the opposite sense.

An even more preferred embodiment of this process uses at least a third drawing roll which rotates with a tangential velocity v₃ which is higher than the one of the second roll (v₂). In this embodiment, preferably, the third drawing roll is opposed by a contrarotating auxiliary roll as well.

In the process of the invention, the polymer film is drawn in solid state (i.e. at a temperature below its melting point), but at a temperature close to its melting temperature however, for instance from 10 to 50° C. below it and more preferably, from 15 to 40° C. below it.

Preferably, drawing takes place in line with the film manufacture by extrusion, calendaring . . . . In that case, the film must be cooled at a temperature lower than its crystallization temperature before stretching. Alternatively, drawing may take place on a film heated at the required temperature. For instance, temperature conditioning cylinders may be used to respectively cool or heat the films at the required temperature.

The key feature of this embodiment, as explained above, lies in the fact of having 2 drawing rolls which draw the film at a high speed on a short distance. This does not imply however that said 2 rolls should be the first of the drawing installation (including a succession of drawing rolls). In fact, according to a preferred embodiment, each drawing roll is doubled and consists in a pair of rolls rotating at the same speed. In other words, the 2 first rolls are rotating at the same speed and the second ones as well (and even the two 3^{rd} rolls, if any) so that the required high drawing ratio is observed between the second roll of the first pair, and the first roll of the second pair. In practice, good results have been obtained with 3 pairs of drawing rolls rotating with increasing tangential velocities v1, v2 and v3 and with the above mentioned criteria being answered by the second roll of the first set and by the first roll of the second set of rolls.

Furthermore, preferably, the distance between succeeding rolls rotating with different tangential velocities (i.e. the free length of the polymer film which is subjected to stretching) is reduced thereby suppressing the shrinking of the width of the film between said rolls. Therefore, most preferably, the drawing cylinders mentioned above are put in line, so that the film describes a “S” curve between them. It is then advantageous to position the contrarotating auxiliary rolls on alternate sides of the drawing rolls, i.e. in front of the part of the cylinder encompassing the “S”.

The contrarotating auxiliary roll(s) used in this embodiment of the invention most preferably bear a rubber like cylindrical jacket. This, especially when combined with the use of drawing rolls which are surface treated, gives quite good adherence to said rolls.

In the process of this embodiment, the pressure exerted by the contrarotating auxiliary rolls on the film is low so that it does not lead to deformation (flattening) of said film. The film is merely gripped between the drawing and the auxiliary cylinder(s), not compressed between them since that would not allow soliciting the molecular entanglements as is believed to happen. Said gripping may be performed by applying compressed air on said cylinders. Examples of pressure values acting on said rolls are from a few bars (like 6 for instance, which is currently available with compressed air systems)

The present invention also relates to the use of an oriented polymer strip obtained by said process for reinforcing a tube.

The oriented polymer strips according to the present invention, although produced at a high rate (velocity) and in few drawing steps, exhibit comparable mechanical properties in longitudinal direction as the mono-axially oriented polymer films of the prior art but show superior resistance in the direction perpendicular to the orientation of the polymer chains, i.e. in transverse direction. The edges of the mono-axially oriented polymer films may be cut by conventional cutting tools. Costly and highly sophisticated cutting systems such as CO₂ lasers and water jets are not required to provide oriented polymer strips of well defined and precise dimensions. Thus, the process provides oriented polymer strips which are optimized for reinforcing tubes. Furthermore, when tubes wrapped by such reinforcing polymer strips are subjected to physical tests, noisy crashes upon bursting do not appear.

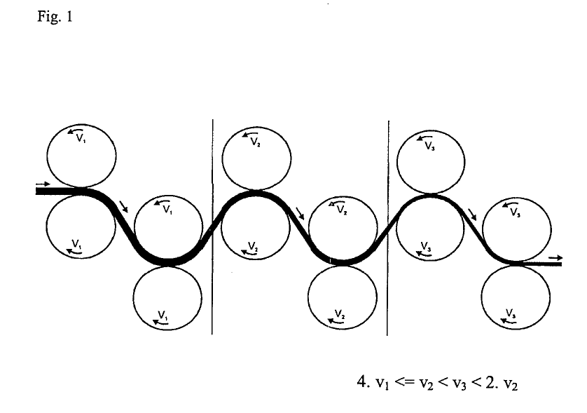

The present invention is illustrated in a non limitative way by FIG. 1 and the following examples, which use a drawing installation including drawing rolls as set forth in FIG. 1.

These rolls consist of 3 pairs of drawing rolls all in line, opposed by 3 pairs of contrarotating auxiliary rolls positioned on alternate sides of said line, in order to press the film on the surface of the drawing rolls. In each pair of cylinders, both rolls are rotating at the same tangential speed, respectively v₁, v₂ and v₃, with v₂ being at least 4 times v₁ and v3 being higher than v₂, but less than twice v₂.

The drawing installation used in the examples includes such a set of rolls and more specifically, comprises: an extruder (Kuhne with a 60 mm screw and equipped with a flat Johnson die of 300×8 mm) for making polymer films of about 260 mm wide; 2 sets of cylinders for cooling the polymer at 50° C. and crystallizing it (the last set being only required for high thicknesses); two cylinders ensuring a fixed point at which the speed is controlled; 6 cylinders for the temperature conditioning of the film prior to its orientation (the temperature of the strip being at about 90° C. at its entrance in these cylinders and at about 115° C. at its exist thereof); the orientation section (made of 3 pairs of cylinders as in FIG. 1, having a diameter D=130 mm and being spaced from each other by about d=30 mm); a last cutting section where the edges of the film are cut off to the desired width (depending on the diameter of the tube which it is intended for).

### EXAMPLE (ACCORDING TO THE INVENTION)

The above described installation was used for making HDPE (Eltex TUB121 from BPS) strips using the following drawing speeds: v₁=about 1 m/min; v₂=about 6.5 m/min and v₃=about 9 m/min; the first draw ratio was hence of about 550% and the second one, of about 30% so that the film was stretched to about 8.5 times in total. Considering the above mentioned size and position of the cylinders, this leads to the following relations:

v₂−v₁=5.5 m/min=91.7 mm.s⁻¹

L≅π.D+d=234 mm

(v₂−v₁)/L=0.39

The pressure applied by the rubber cylinders was of about 6 bars (that of the compressed air applied on it) so that the strips were not really compressed (flattened down) but merely prevented from slipping. The film width was about 230 mm and it could be cut easily to the ideal width of 200 mm, without breaking it, and be wound around the pipe of 117 mm diameter with the above mentioned ideal angle of 54.7°.

### COMPARATIVE EXAMPLE (NOT ACCORDING TO THE INVENTION)

All conditions were the same than in the example, except that the contrarotating cylinders were not used; hence, a much lower drawing ratio was obtained (about 6 times only) and a necking of from 260 to 140 mm was observed. It was observed that in practice, the drawing length was in fact double, because the film only reached the speed v2 at the second cylinder of the second set, and not at the first one. Hence, the following relations were observed:

v₂−v₁=5.5 m/min=91.7 mm.s⁻¹

L≅2.(π.D+d)=468 mm

(v₂−v₁)/L=0.20

The film obtained was brittle, inhomogeneous as far as it thickness is concerned and the ideal width (200 mm) for getting the ideal winding angle (54.7°) could not be reached.

1-10. (canceled)

11. A process for the manufacture of an oriented strip comprising a semi-crystalline polymer according to which a film comprising said polymer is drawn in a longitudinal direction on a length L between two points at which the film moves at a respective linear velocity of v₁ and v₂ during its drawing,
wherein v₁, v₂ and L answer the following criteria:
(v₂−v₁)/L>0.22 s⁻¹,
wherein the drawing is made by means of at least two independently driven drawing rolls having their axes of rotation perpendicular to the longitudinal direction of polymer film and rotating the same sense but with different tangential velocities v₁ and v₂ and that the film is prevented from slipping of the drawing rolls by means of contrarotating auxiliary rolls, having their axes of rotation perpendicular to the longitudinal direction of the polymer film and rotating with the same tangential velocity but in the opposite sense.

12. The process according to claim 11, characterized in that the semi-crystalline polymer is a polyolefin.

13. The process according to claim 12, characterized in that the polyolefin is a bimodal HDPE (high density polyethylene) resin having a MI (Melt Index according to ISO 1133 under 5 kg and 190° C.) of less than 2 g/10 min.

14. The process according to claim 13, characterized in that the drawing rolls are surface treated to enhance adhesion of the polymer film thereon.

15. The process according to claim 11, characterized in that the drawing uses at least a third drawing roll which rotates with a tangential velocity v₃ which is higher than the one of the second roll (v₂).

16. The process according to the preceding claim 15, characterized I that said third drawing roll is opposed by contrarotating auxiliary roll.

17. The process according to claim 11, characterized in that the drawing roll is doubled and consists in a pair of rolls rotating at the same speed.

18. The process according to claim 11, characterized in that the drawing rolls are in line and in that the contrarotating rolls are positioned on alternated sides thereof.

19. Use of an oriented polymer strip obtained from the process according to claim 11 for reinforcing a tube.

20. The process according to claim 14, characterized in that the drawing uses at least a third drawing roll which rotates with a tangential velocity V3 which is higher than the one of the second roll (v₂).

21. The process according to the preceding claim 20, characterized I that said third drawing roll is opposed by contrarotating auxiliary roll.

22. The process according to claim 14, characterized in that the drawing roll is doubled and consists in a pair of rolls rotating at the same speed.

23. The process according to claim 15, characterized in that the drawing roll is doubled and consists in a pair of rolls rotating at the same speed.

24. The process according to claim 16, characterized in that the drawing roll is doubled and consists in a pair of rolls rotating at the same speed.

25. The process according to claim 20, characterized in that the drawing roll is doubled and consists in a pair of rolls rotating at the same speed.

26. The process according to claim 21, characterized in that the drawing roll is doubled and consists in a pair of rolls rotating at the same speed.

27. The process according to claim 14, characterized in that the drawing rolls are in line and in that the contrarotating rolls are positioned on alternated sides thereof.

28. The process according to claim 15, characterized in that the drawing rolls are in line and in that the contrarotating rolls are positioned on alternated sides thereof.

29. The process according to claim 16, characterized in that the drawing rolls are in line and in that the contrarotating rolls are positioned on alternated sides thereof.

30. The process according to claim 17, characterized in that the drawing rolls are in line and in that the contrarotating rolls are positioned on alternated sides thereof.

31. The process according to claim 20, characterized in that the drawing rolls are in line and in that the contrarotating rolls are positioned on alternated sides thereof.

32. The process according to claim 21, characterized in that the drawing rolls are in line and in that the contrarotating rolls are positioned on alternated sides thereof.
